(19) United States
(12) Patent Application Publication
(10) Pub. No.: US 2013/0321480 A1
(43) Pub. Date: Dec. 5, 2013

(54) DRIVING METHOD OF ORGANIC LIGHT EMITTING DISPLAY DEVICE

(71) Applicant: SAMSUNG DISPLAY CO., LTD., Yongin-si (KR)

(72) Inventor: Yang-Wan Kim, Yongin-si (KR)

(73) Assignee: SAMSUNG DISPLAY CO. LTD., Yongin-si (KR)

(21) Appl. No.: 13/651,308

(22) Filed: Oct. 12, 2012

(30) Foreign Application Priority Data
Jun. 5, 2012 (KR) 10-2012-0060412

(51) Int. Cl. G09G 3/30

(52) U.S. Cl. 345/690; 345/77

(57) ABSTRACT

A method of driving organic light emitting display device includes: supplying data signals during scanning periods of each of n subfields of one frame, where n is a natural number greater than or equal to 2; and generating light in each of the pixels, the light corresponding to the data signals and being emitted during light emitting periods of one or more of the subfields, wherein a pixel set to be in a non-light emitting state during an i-th subfield is set to be in the non-emitting state during subfields of the one frame after the i-th subfield.

### CROSS-REFERENCE TO RELATED APPLICATION

This application claims priority to and the benefit of Korean Patent Application No. 10-2012-0060412, filed on Jun. 5, 2012, in the Korean Intellectual Property Office, the entire content of which is incorporated herein by reference.

### BACKGROUND

1. Field

Embodiments of the present invention relate to a method of driving an organic light emitting display device, and more particularly, to a driving method of an organic light emitting display device capable of improving display quality.

2. Description of the Related Art

Recently, various flat panel display devices having reduced weight and volume, which are disadvantages of cathode ray tube display devices, have been developed. The types of flat panel display devices include a liquid crystal display, a field emission display, a plasma display panel, an organic light emitting display device, and the like.

Among the various types of flat panel display devices, the organic light emitting display device, which displays an image using organic light emitting diodes which generate light by the recombination of electrons and holes, has a fast response speed and can be driven at a low power. However, in some organic light emitting display devices, there is a problem that a spot (e.g., a visual artifact) is generated in a low luminance area. More specifically, in some organic light emitting display devices, variations in the threshold voltages of the driving transistors included in the pixels are compensated for by using a circuit. However, the threshold voltages of the driving transistors may not be properly compensated for in the low luminance areas due to a low current (e.g., low driving current), such that a spot, or other visual artifact, is generated.

### SUMMARY

An aspect of embodiments of the present invention is directed to providing a method of driving an organic light emitting display device.

According to one embodiment of the present invention, a method of driving an organic light emitting display device includes: supplying data signals during scanning periods of each of n subfields included in one frame, where n indicates a natural number greater than or equal to 2; and generating light in each of the pixels, the light corresponding to the data signals and being emitted during scanning periods of one or more of the subfields, wherein a pixel set to be in a non-light emitting state during an i-th subfield of the n subfields of the one frame is set to be in the non-light emitting state during subfields of the one frame after the i-th subfield.

The lengths of light emitting periods of the subfields may be different from each other. The light emitting period of the i-th subfield may be longer than that of a light emitting period of an i-1-th subfield. The data signals may correspond to different gray levels. A pixel emitting light in j+1 subfields may represent (or display) a higher gray level as compared to a pixel emitting light in only j subfields, where j is a natural number. A pixel representing a particular gray level sequentially may emit light during a first subfield and a second subfield so that the particular gray level is represented (or displayed).

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a diagram showing a driving method of an organic light emitting display device according to one embodiment of the present invention; and

FIG. 2 is a diagram showing an example of representing various gray levels according to one embodiment of the present invention.

### DETAILED DESCRIPTION

Hereinafter, certain exemplary embodiments of the present invention will be described with reference to the accompanying drawings. Here, when a first element is described as being coupled to a second element, the first element may be directly coupled to the second element or may be indirectly coupled to the second element via a third element. Further, some of the elements that are not essential to the complete understanding of the invention are omitted for clarity. Also, like reference numerals refer to like elements throughout.

In the following detailed description, only certain embodiments of the present invention have been shown and described, simply by way of illustration. As those skilled in the art would realize, the described embodiments may be modified in various different ways, all without departing from the spirit or scope of embodiments of the present invention. Accordingly, the drawings and description are to be regarded as illustrative in nature and not restrictive. In addition, when an element is referred to as being “on” another element, it can be directly on another element or be indirectly on the another element with one or more intervening elements interposed therebetween. Also, when an element is referred to as being “connected to” another element, it can be directly connected to the another element or can be indirectly connected to the another element with one or more intervening elements interposed therebetween. Hereinafter, like reference numerals refer to like elements.

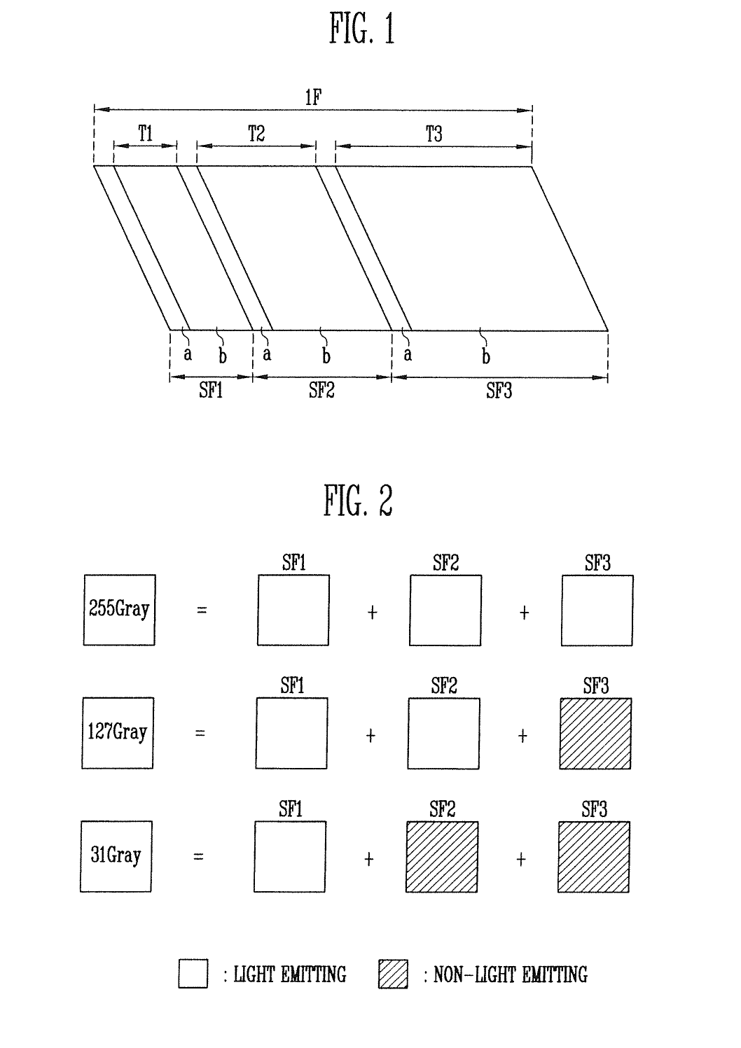

Hereinafter, embodiments of the present invention will be described in detail with reference to FIGS. 1 and 2 so that they can be easily practiced by those skilled in the art to which embodiments of the present invention pertain.

FIG. 1 is a diagram showing a method of driving an organic light emitting display device according to one embodiment of the present invention. Although FIG. 1 shows that one frame is divided into three subfields SF1 to SF3 for convenience of explanation, embodiments of the present invention are not limited thereto.

Referring to FIG. 1, one frame 1F of driving the organic light emitting display device according to one embodiment of the present invention is divided into a plurality of the subfields SF1 to SF3. In addition, each of the subfields SF1 to SF3 is divided into a scanning period (or scan period) “a” and a light emitting period “b.”

During the scanning period a, scanning signals (or scan signals) are supplied to scanning lines (or scan lines) and data signals synchronized with the scanning signals are supplied to data lines. For example, the scanning signals may be sequentially supplied to the scanning lines, such that the pixels coupled to a same one of the scanning lines are selected in a horizontal line unit. In this case, the data signals supplied to the data lines are supplied to the pixels selected by the scanning signals.

During the light emitting period b, the pixels emit the light in accordance with the data signals supplied to the pixels during the scanning period. In other words, during the light emitting period b, each of the pixels disposed in a panel generates light having the same luminance or different luminance, the luminance of the light corresponding to the data signals supplied to the pixels.

According to one embodiment of the present invention, in the case of representing a gray level (e.g., displaying a light having a gray level or gray scale level), the pixel emits the light in a sequence of the first subfield SF1, the second subfield SF2, and the third subfield SF3. In order words, when a gray level (e.g., a predetermined or supplied gray level) is represented (or displayed) by a specific pixel, the first subfield SF1 is set to be in a light emitting state.

Here, in the case in which the gray level is represented during the first subfield SF1, the remaining subfields are set to be in a non-light emitting state. On the other hand, in one embodiment of the present invention, when the gray level is not sufficiently represented (or displayed) during the first subfield SF1, the second subfield SF2 is set to be in the emitting state. In addition, when the gray level is represented during the second subfield SF2, the remaining subfields (e.g., SF3) are set to be in the non-light emitting state. On the other hand, when the gray level is not sufficiently represented (or displayed) during the second subfield SF2, the third subfield SF3 is set to be in the emitting state.

That is, according to one embodiment of the present invention, the pixels emit the light in a sequence of the first subfield SF1 to an i-th subfield (i indicates a natural number) and represents (or displays) the gray level. In some embodiments of the present invention, the i-th subfield is set to be in the non-light emitting state when the light is not emitted during an i-1-th subfield.

More specifically, as shown in FIG. 2, in one embodiment of the present invention, the pixels representing (or displaying or outputting light corresponding to) a low gray level, for example, gray levels of 0 to 63, emit light only during a period of the first subfield SF1. To this end, the data signals corresponding to the gray levels of 0 to 63 are supplied to the respective pixels during the scanning period of the first subfield SF1.

According to one embodiment of the present invention, a pixel displaying a low gray level emits light only during the period of the first subfield SF1, and is set to be in the non-light emitting state during periods of the second subfield SF2 and the third subfield SF3. Accordingly, a pixel displaying a low gray level during the period of the first subfield SF1 may be set to generate light having a high luminance during a short period of time. In this case, in the pixel displaying the low gray level, a higher current may be used as compared to related art (e.g., other organic light emitting displays) during the period of the first subfield SF1, such that the threshold voltage of the driving transistor may be stably (e.g., uniformly or predictably) compensated for.

For example, a pixel representing a gray level of 31 according to the related art emits the light corresponding to the low current during one frame period 1F. In contrast, a pixel representing the gray level of 31 according to one embodiment of the present invention emits the light only during the period of the first subfield SF1, which is a portion of the period of one frame. As a result, the pixel is driven with a higher current during SF1 to emit the light (e.g., a higher current as compared to the pixel according to related art). When high current flows in the pixel as described above, the threshold voltage of the driving transistor may be stably (e.g., uniformly or predictably) compensated for. Therefore, display quality in the low gray levels may be improved.

In addition, pixels according to one exemplary embodiment of the present invention representing an intermediate gray level, for example, a gray level of 64 to 127, emit the light during the periods of the first subfield SF1 and the second subfield SF2. In this case, a data signal corresponding to a gray level of 63 is supplied to each of the pixels during the scanning period of the first subfield SF1 and data signals corresponding to the gray levels of 1 to 64 are supplied to each of the pixels during the scanning period of the second subfield SF2.

For example, a particular pixel representing a gray level of 127 is supplied with a data signal corresponding to the gray level of 63 during the period (e.g., the scanning period) of the first subfield SF1 and a data signal corresponding to a gray level of 64 is supplied during the period (e.g., the scanning period) of the second subfield SF2. In this case, in the particular pixel, a gray level of 127 is represented (or displayed) by the sum of light emitting periods of the first subfield SF1 and the second subfield SF2.

In addition, pixels representing a high gray level, for example, gray levels of 128 to 255 emit light during the periods of the first, second, and third subfields SF1, SF2, and SF3. In this case, each of the pixels representing the high gray level is supplied with a data signal corresponding to a gray level of 63 during the scanning period of the first subfield SF1, a data signal corresponding to the gray level of 64 during a scanning period of the second subfield SF2, and is supplied with a data signal corresponding to gray levels from 1 to 128 during a scanning period of the third subfield SF3.

For example, according to one embodiment of the present invention, a particular pixel representing the 255 gray level is supplied with a data signal corresponding to the gray level of 63 during a scanning period of the first subfield SF1, the gray level of 64 during a scanning period of the second subfield SF2, and a gray level of 128 during a scanning period of the third subfield SF3. Meanwhile, according to one embodiment of the present invention, in the high gray level area, the light is emitted during one frame period 1F (e.g., an entire frame period). Accordingly, the current does not increase as compared to the related art in order to implement the high gray level area.

Additionally, according to one embodiment of the present invention, the light emitting periods of the subfields (e.g., the length of each of the subfields) are set to be different from each other. For example, the light emitting period of the i-th subfield is set to be wider (e.g., longer in time) than that of the i-1-th subfield. For example, in the case in which the light emitting period of the first subfield SF1 is set to have a length of a first period T1, the light emitting of the second subfield SF2 is set to have a length of a second period T2 wider (or longer) than the first period T1. In addition, the light emitting period of the third subfield SF3 is set to have a length of a third period T3 wider (or longer) than the second period T2.

In embodiments in which the light emitting period of the i-th subfield is wider than that of the i-1-th subfield, a current flowing in the pixel displaying a low gray level may be high, thereby making it possible to stably represent light having a low gray level luminance. In addition, in a pixel displaying (or emitting light having) a high gray level, the current may flow during a sufficiently wide period, such that a decrease in a lifespan of the pixel, or the like, due to an increase in current may be reduced or prevented.

As described above, when using a driving method of an organic light emitting display device according to the embodiments of the present invention, one frame is divided into a plurality of subfields. Here, the pixel representing light having a low gray level is set to be in a light emitting state during period of a short subfield. As such, the pixel representing the low gray level is driven with a high current in order to display the low gray level during the short time (of the short subfield), thereby making it possible to improve the quality of the image displayed.

While embodiments of the present invention have been described in connection with certain exemplary embodiments, it is to be understood that the invention is not limited to the disclosed embodiments, but, on the contrary, is intended to cover various modifications and equivalent arrangements included within the spirit and scope of the appended claims and equivalents thereof.

What is claimed is:

1. A method of driving an organic light emitting display device, the method comprising:
supplying data signals during scanning periods of each of n subfields of one frame, where n is a natural number greater than or equal to 2; and
generating light in each of the pixels, the light corresponding to the data signals and being emitted during light emitting periods of one or more of the subfields,
wherein a pixel set to be in a non-light emitting state during an i-th subfield of the n subfields is set to be in the non-light emitting state during subfields of the one frame after the i-th subfield.

2. The method according to claim 1, wherein the lengths of the light emitting periods of the subfields are different from each other.

3. The method according to claim 2, wherein the light emitting period of the i-th subfield is longer than a light emitting period of an i-1-th subfield.

4. The method according to claim 1, wherein the data signals correspond to different gray levels.

5. The method according to claim 1, wherein a pixel emitting light in j+1 subfields represents a higher gray level as compared to a pixel emitting light only in the first j subfields, where j is a natural number.

6. The method according to claim 1, wherein a pixel representing a particular gray level sequentially emits light during a first subfield and a second subfield so that the particular gray level is represented.
